(19) United States
(12) Patent Application Publication
(10) Pub. No.: US 2023/0299334 A1
(43) Pub. Date: Sep. 21, 2023

(54) SULFIDE SOLID ELECTROLYTE AND SOLID STATE BATTERY

(71) Applicant: TOYOTA JIDOSHA KABUSHIKI KAISHA, Toyota-shi Aichi-ken (JP)

(72) Inventor: Keiichi MINAMI, Tagata-gun Shizuoka-ken (JP)

(73) Assignee: TOYOTA JIDOSHA KABUSHIKI KAISHA, Toyota-shi Aichi-ken (JP)

(21) Appl. No.: 18/119,542

(22) Filed: Mar. 9, 2023

(30) Foreign Application Priority Data
Mar. 18, 2022 (JP) 2022-043694

(51) Int. Cl. H01M 10/0562; H01M 10/0525

(52) U.S. Cl. CPC H01M 10/0562; H01M 10/0525; H01M 2300/008

(57) ABSTRACT

A main object of the present disclosure is to provide a sulfide solid electrolyte including water resistance while maintaining an argyrodite type crystal structure. The present disclosure achieves the object by providing a sulfide solid electrolyte including an argyrodite type crystal phase, and containing Li, Ge, Sb, S, I, and A, the A is an anion with ionic radius larger than that of a sulfide ion.

### CROSS-REFERENCE TO RELATED APPLICATIONS

This application is based upon and claims the benefit of priority of the prior Japanese Patent Application No. 2022-043694, filed on Mar. 18, 2022, the entire contents of which are incorporated herein by reference.

### TECHNICAL FIELD

The present disclosure relates to a sulfide solid electrolyte and a solid state battery.

### BACKGROUND ART

A solid state battery is a battery including a solid electrolyte layer between a cathode layer and an anode layer, and one of the aspects thereof is that the simplification of a safety device may be more easily achieved compared to a liquid-based battery including a liquid electrolyte containing a flammable organic solvent. As a solid electrolyte used for a solid state battery, a sulfide solid electrolyte has been known.

Patent Literature 1 discloses a sulfide solid electrolyte comprising two kinds or more of an element X selected from lithium, phosphorus, sulfur and halogen element; and has an argyrodite type crystal structure, wherein a molar ratio b of sulfur with respect to phosphorus which is S/P, and a molar ratio c of the element X with respect to phosphorus which is X/P satisfy a specified relation.

### CITATION LIST

### Patent Literature

Patent Literature 1: International Application Publication: WO 2018/047565

### SUMMARY OF DISCLOSURE

### Technical Problem

A sulfide solid electrolyte with an argyrodite type crystal structure has, for example, a composition represented by Li₆PS₅I. Also, in order to improve resistant to oxidation, a sulfide solid electrolyte in which P is substituted with Ge and Sb has been studied. Meanwhile, in the sulfide solid electrolyte with an argyrodite type crystal structure, when a proportion of I (iodine) is increased, the argyrodite type crystal structure may not be maintained although the water resistance of the sulfide solid electrolyte may be easily improved.

The present disclosure has been made in view of the above circumstances, and a main object thereof is to provide a sulfide solid electrolyte including water resistance while maintaining an argyrodite type crystal structure.

### Solution to Problem

In order to achieve the object, the present disclosure provides a sulfide solid electrolyte with an argyrodite type crystal phase; and containing Li, Ge, Sb, S, I, and A, the A is an anion with ionic radius larger than that of a sulfide ion.

According to the present disclosure, the A anion is included, and thus a sulfide solid electrolyte including water resistance while maintaining an argyrodite type crystal structure may be achieved. Further, according to the present disclosure, as a cation, the sulfide solid electrolyte contains Ge and Sb of which resistant to oxidation is better than that of P, and thus a sulfide solid electrolyte with resistant to oxidation may be achieved.

In the disclosure, the sulfide solid electrolyte may not contain P.

In the disclosure, the sulfide solid electrolyte may contain P, and a proportion of P with respect to a total of Ge, Sb, and P may be 50 mol % or less.

In the disclosure, the A may include a polyatomic anion with a plurality of O.

In the disclosure, the polyatomic anion may include C, S, or N as a cation.

In the disclosure, the A may include at least one of a carbonate ion CO₃²⁻ and a sulfate ion SO₄²⁻.

In the disclosure, the A may include a bromide ion.

In the disclosure, the sulfide solid electrolyte may have a composition represented by (2-a-b)Li₂S-aLiI-bLi_{α}A-Li₄ (Ge,Sb) S₄; and the “a” may satisfy 0<a<2, the “b” may satisfy 0<b<2, the “a” and the “b” may satisfy 0<a+b<2, and the “α” may be a value corresponding to a valence of the A.

In the disclosure, the “a” and the “b” may satisfy 1.5≤a+b≤1.9.

In the disclosure, the “a” may satisfy 0.8≤a≤1.2.

In the disclosure, the “b” may satisfy 0.4≤b≤1.0.

The present disclosure also provides a solid state battery including a cathode layer, an anode layer, and a solid electrolyte layer formed between the cathode layer and the anode layer, wherein at least one of the cathode layer, the anode layer, and the solid electrolyte layer contains the above described sulfide solid electrolyte.

According to the present disclosure, the above described sulfide solid electrolyte is used, and thus the solid state battery may have water resistance.

### Effects of Disclosure

The sulfide solid electrolyte in the present disclosure exhibits an effect of water resistance while maintaining an argyrodite type crystal structure.

### BRIEF DESCRIPTION OF DRAWINGS

FIG. 1 is a flow chart exemplifying the method for producing the sulfide solid electrolyte in the present disclosure.

FIG. 2 is a schematic cross-sectional view exemplifying the solid state battery in the present disclosure.

FIG. 3 is the result of an XRD measurement for a sulfide solid electrolyte obtained in Example 1.

FIG. 4 is the result of an XRD measurement for a sulfide solid electrolyte obtained in Comparative Example 1.

FIG. 5 is the result of an XRD measurement for a sulfide solid electrolyte obtained in Comparative Example 2.

### DESCRIPTION OF EMBODIMENTS

The sulfide solid electrolyte and the solid state battery in the present disclosure will be hereinafter explained in details.

### A. Sulfide Solid Electrolyte

The sulfide solid electrolyte in the present disclosure has an argyrodite type crystal phase, and contains Li, Ge, Sb, S, I, and A, the A is an anion with ionic radius larger than that of a sulfide ion.

According to the present disclosure, the A anion is included, and thus a sulfide solid electrolyte including water resistance while maintaining an argyrodite type crystal structure may be achieved. Here, a typical composition of the sulfide solid electrolyte with the argyrodite type crystal structure is 2Li₂S—Li₃PS₄ (=Li₇PS₆). In this composition, the sulfide ion (S²⁻) included in Li₂S easily reacts with water unlike the sulfide ion (sulfide ion that forms P—S bond) included in Li₃PS₄. For this reason, substitution of a part of Li₂S with LiI has been tried.

For example, the sulfide solid electrolyte having a composition represented by Li₆PS₅I corresponds to “a”=1 in (2-a)Li₂S-aLiI-Li₃PS₄. Meanwhile, in order to improve resistance to oxidation, a sulfide solid electrolyte in which P is substituted with Ge and Sb has been studied. Such a sulfide solid electrolyte is represented by, for example, (2-a)Li₂S-aLiI-Li₄(Ge,Sb)S₄ (0<a<2). From the viewpoint of improving the water resistance of the sulfide solid electrolyte, increasing the proportion “a” of I (LiI) is effective. However, if the proportion of I is increased, the argyrodite type crystal structure may not be maintained. In contrast, in the present disclosure, in addition to I ions, by using the A anion having an ionic radius larger than that of the sulfide ion, the proportion of the sulfide ion (S²⁻) included in Li₂S may be reduced while maintaining the argyrodite type crystal structure. As a result, a sulfide solid electrolyte with water resistance is obtained. Further, in the present disclosure, the sulfide solid electrolyte contains, as a cation, Ge and Sb that have more resistance to oxidation compared to that of P, and thus the sulfide solid electrolyte may have resistance to oxidation.

The sulfide solid electrolyte in the present disclosure has an argyrodite type crystal phase. Whether the sulfide solid electrolyte has the argyrodite type crystal phase can be confirmed by an X-ray diffraction (XRD) measurement. In some embodiments, the sulfide solid electrolyte has peaks at 2θ=17.0°±0.5°, 24.1°±0.5°, 28.3°±0.5°, 29.6°±0.5°, and 38.6°±0.5° in an XRD measurement using a CuKα ray. These peaks are typical peaks of the argyrodite type crystal phase. Each of these peaks may shift in the range of ±0.3°, and may shift in the range of ±0.1°.

In some embodiments, the sulfide solid electrolyte has the argyrodite crystal phase as a main phase. The “main phase” refers to a crystal phase belonging to the peak with the highest intensity in the XRD measurement using a CuKα ray. Also, in the XRD measurement using a CuKα ray to the sulfide solid electrolyte, a peak of LiI may or may not be observed.

The sulfide solid electrolyte in the present disclosure contains Li, Ge, Sb, S, I, and A, the A is an anion with ionic radius larger than that of a sulfide ion. The sulfide solid electrolyte contains, as a cation, at least Li, Ge, and Sb. The sulfide solid electrolyte may contain just Li, Ge, and Sb as the cation, and may further contain additional cation. Examples of the additional cation may include P. In the sulfide solid electrolyte, a total proportion of Ge and Sb with respect to all the cations excluding Li is, for example, 50 mol % or more, may be 70 mol % or more, may be 90 mol % or more, and may be 100 mol % or more. Also, the proportion of Ge with respect to a total of Ge and Sb is, for example, 1 mol % or more and 99 mol % or less, and may be 20 mol % or more and 80 mol % or less.

In some embodiments, the sulfide solid electrolyte does not contain P. The reason therefor is to obtain a sulfide solid electrolyte with resistance to oxidation. Meanwhile, the sulfide solid electrolyte may contain P. The reason therefor is to easily precipitate the argyrodite type crystal phase. The proportion of P with respect to a total of Ge, Sb and P is, for example, 50 mol % or less, may be 30 mol % or less, and may be 10 mol % or less. Meanwhile, the proportion of P is, for example, 1 mol % or more, and may be 5 mol % or more.

The sulfide solid electrolyte contains, as an anion, at least S, I, and A. The A is an anion with ionic radius larger than that of a sulfide ion. Also, the A is an anion other than an iodide ion (I⁻). The sulfide solid electrolyte may contain just one kind of the anion corresponding to the A, and may contain two kinds or more thereof.

The A is, for example, a polyatomic anion. In some embodiments, the polyatomic anion includes, for example, a plurality of O. The ionic radius of an oxide ion (O²⁻) alone is 140 μm, which is smaller than the ionic radius (184 μm) of a sulfide ion (S²⁻). Meanwhile, a polyatomic anion with a plurality of O is usually larger than the ionic radius of the sulfide ion (S²⁻).

The polyatomic anion may include C, S, or N as a cation. Examples of the polyatomic anion with C may include a carbonate ion (CO₃²⁻) and a hydrogen carbonate ion (HCO₃⁻). Examples of the polyatomic anion with S may include a sulfate ion (SO₄²⁻) and a sulfite ion (SO₃²⁻). Examples of the polyatomic anion with N may include a nitrate ion (NO₃⁻) and a nitrite ion (NO₂⁻).

The A may be a monoatomic anion. Typical examples of the monoatomic anion may include a halide ion (excluding an iodide ion). Under consideration of a fluoride ion (136 μm), a chloride ion (181 μm), and a bromide ion (195 μm), the monoatomic anion typically corresponding to the A may be the bromide ion.

The sulfide solid electrolyte may contain, as the anion, just S, I, and A, and may contain an additional anion thereto. Examples of the additional anion may include Cl. The total proportion of S, I and A with respect to all the anions in the sulfide solid electrolyte is, for example, 50 mol % or more, may be 70 mol % or more, may be 90 mol % or more, and may be 100 mol %. Also, the proportion (molar ratio) of the A with respect to I is, for example, 0.4 or more and may be 0.6 or more. Meanwhile, the proportion (molar ratio) of the A with respect to I is, for example, 1.2 or less, may be 1.0 or less, and may be 0.8 or less.

In some embodiments, the sulfide solid electrolyte has a composition represented by (2-a-b)Li₂S-aLiI-bLi_{α}A-Li₄(Ge,Sb)S₄. In this composition, “a” satisfies 0<a<2, “b” satisfies 0<b<2, and “a” and “b” satisfy 0<a+b<2.

The “a” is usually larger than 0, may be 0.4 or more, and may be 0.8 or more. The “a” is usually smaller than 2, may be 1.6 or less, and may be 1.2 or less. Also, the “b” is usually larger than 0, may be 0.2 or more, and may be 0.4 or more. Meanwhile, the “b” is usually smaller than 2, may be 1.2 or less, and may be 1.0 or less. Also, the “a” and the “b” are usually larger than 0, may be 0.5 or more, may be 1.0 or more, and may be 1.5 or more. Meanwhile, the “a” and the “b” are usually smaller than 2, may be 1.95 or less, and may be 1.9 or less.

Also, in the composition, the α is a value corresponding to the valence of the A. For example, when the A is a carbonate ion (CO₃²⁻), the α is 2 (Li₂CO₃). For example, when the A is a bromide ion (Br⁻), the α is 1 (LiBr). Also, in the composition, a part of Ge or Sb may be substituted with P.

The sulfide solid electrolyte in the present disclosure has high water resistance. The generation amount of H₂S in the later described water resistance test is, for example, 25 ppm/h or less, may be 20 ppm/h or less, and may be 10 ppm/h or less. In some embodiments, the sulfide solid electrolyte has high ion conductivity. The ion conductivity at 25° C. is, for example, 1*10⁻⁴ S/cm or more, and may be 5*10⁻⁴ S/cm or more.

Examples of the shape of the sulfide solid electrolyte may include a granular shape. Also, the average particle size (D₅₀) of the sulfide solid electrolyte is, for example, 0.1 μm or more and 50 μm or less. The average particle size (D₅₀) can be obtained from a result of a particle distribution measurement by a laser diffraction scattering method. There are no particular limitations on the application of the sulfide solid electrolyte, but for example, in some embodiments, it used in a solid state battery.

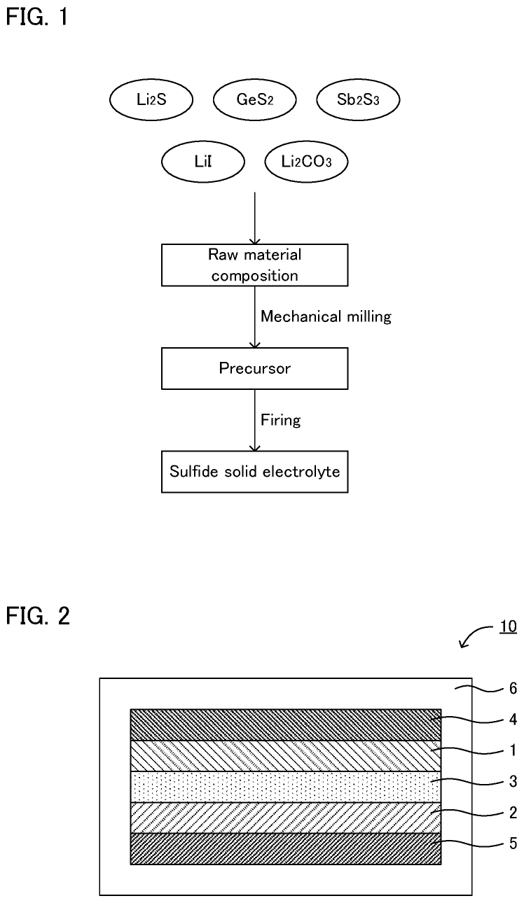

There are no particular limitations on the method for producing the sulfide solid electrolyte in the present disclosure. FIG. 1 is a flow chart illustrating the method for producing the sulfide solid electrolyte in the present disclosure. In FIG. 1, a raw material composition containing Li₂S, GeS₂, Sb₂S₃, LiI, and Li₂CO₃, is prepared. Next, the raw material composition is mixed, for example by as mechanical milling to obtain a precursor (mixing step). Next, the obtained precursor is fired to obtain a sulfide solid electrolyte (firing step).

The mixing step is a step of mixing a raw material composition containing Li, Ge, Sb, S, I, and A to obtain a precursor. Examples of the raw material containing Li may include a Li sulfide. Examples of the Li sulfide may include Li₂S. Examples of the raw material containing Ge may include a Ge sulfide. Examples of the Ge sulfide may include GeS₂. Examples of the raw material containing Sb may include a Sb sulfide. Examples of the Sb sulfide may include Sb₂S₃. The raw material containing S may include a simple substance of sulfur, and the above described various sulfides. Examples of the raw material containing I may include Li iodide (LiI). Examples of the raw material containing A may include a Li salt.

In the mixing step, a precursor (sulfide glass) is obtained by mixing the raw material composition. Examples of the method for mixing the raw material composition may include a mechanical milling method such as ball milling and vibration milling. The mechanical milling method may be dry and may be wet. In some embodiments, the mechanical milling method may be wet from the viewpoint of uniform treatment. There are no particular limitations on the kind of the dispersion medium to be used in the wet mechanical milling.

Various conditions of the mechanical milling are arranged so as to obtain the desired the precursor. For example, when planetary ball milling is used, the raw material composition and balls for crushing thereof will be added, and the treatment will be conducted with a specified revolving speed and time. The weighing table revolving speed of the planetary ball milling is, for example, 150 rpm or more. Meanwhile, the weighing table revolving speed of the planetary ball milling is, for example, 500 rpm or less and may be 250 rpm or less. Also, the treatment time of the planetary ball milling is, for example, 5 minutes or more and may be 10 minutes or more. Meanwhile, the treatment time of the planetary ball milling is, for example, 30 hours or less and may be 25 hours or less.

The firing step is a step of firing the precursor.

Thereby, the above described sulfide solid electrolyte is obtained. In some embodiments, the firing temperature is, for example, a temperature of crystallization temperature or more. Also, firing time is, for example, 1 hour or more and may be 2 hours or more. Meanwhile, the firing time is, for example, 10 hours or less and may be 8 hours or less. Examples of the firing atmosphere may include an inert gas atmosphere and a vacuum.

### B. Solid State Battery

FIG. 2 is a schematic cross-sectional view exemplifying the solid state battery in the present disclosure. Solid state battery 10 illustrated in FIG. 2 includes cathode layer 1 containing a cathode active material, anode layer 2 containing an anode active material, solid electrolyte layer 3 formed between the cathode layer 1 and the anode layer 2, cathode current collector 4 for collecting currents of the cathode layer 1, anode current collector 5 for collecting currents of the anode layer 2, and battery case 6 for storing these members. Further, at least one of the cathode layer 1, the anode layer 2 and the solid electrolyte layer 3 contains the sulfide solid electrolyte described in “A. Sulfide solid electrolyte” above.

According to the present disclosure, the above described sulfide solid electrolyte is used, and thus the solid state battery may have water resistance.

### 1. Cathode Layer

The cathode layer in the present disclosure is a layer containing at least a cathode active material. The cathode layer may contain at least one of a solid electrolyte, a conductive material, and a binder other than the cathode active material.

Examples of the cathode active material may include an oxide active material. Specific examples of the oxide active material may include a rock salt bed type active material such as LiCoO₂, LiMnO₂, LiNiO₂, LiVO₂, and LiNi_{1/3}Co_{1/3}Mn_{1/3}O₂; a spinel type active material such as LiMn₂O₄, Li(Ni_{0.5}Mn_{1.5})O₄; and an olivine type active material such as LiFePO₄, LiMnPO₄, LiNiPO₄, and LiCoPO₄.

The surface of the cathode active material may be coated with a coating layer. The reason therefor is to inhibit the reaction of the cathode active material and the sulfide solid electrolyte. Examples of the material of the coating layer may include a Li ion conductive oxide such as LiNbO₃, Li₃PO₄, and LiPON. The average thickness of the coating layer is, for example, 1 nm or more and 50 nm or less, may be 1 nm or more and 10 nm or less.

In some embodiments, the cathode layer contains the above described sulfide solid electrolyte. In addition, examples of the conductive material may include a carbon material. Examples of the carbon material may include a particulate carbon material such as acetylene black (AB) and Ketjen black (KB), and a fiber carbon material such as carbon fiber, carbon nanotube (CNT), and carbon nanofiber (CNF). Examples of the binder may include a fluorine-based binder such as polyvinylidene fluoride (PVDF). The thickness of the cathode layer is, for example, 0.1 μm or more and 1000 μm or less.

### 2. Solid Electrolyte Layer

The solid electrolyte layer in the present disclosure is a layer containing at least a solid electrolyte. Also, the solid electrolyte layer may contain a binder other than the solid electrolyte. The solid electrolyte and the binder are in the same contents as those described above. In some embodiments, the solid electrolyte layer contains the above described sulfide solid electrolyte. The thickness of the solid electrolyte layer is, for example, 0.1 μm or more and 1000 μm or less.

### 3. Anode Layer

The anode layer in the present disclosure is a layer containing at least an anode active material. Also, the anode layer may contain at least one of a solid electrolyte, a conductive material, and a binder other than the anode active material.

Examples of the anode active material may include a metal active material and a carbon active material. Examples of the metal active material may include In, Al, Si, and Sn. Meanwhile, examples of the carbon active material may include methocarbon microbeads (MCMB), highly oriented pyrolitic graphite (HOPG), hard carbon, and soft carbon.

The solid electrolyte, the conductive material, and the binder are in the same contents as those described above. In some embodiments, the anode layer contains the above described sulfide solid electrolyte. The thickness of the anode layer is, for example, 0.1 μm or more and 1000 μm or less.

### 4. Other Constitutions

The solid state battery in the present disclosure usually comprises a cathode current collector for collecting currents of the cathode active material and an anode current collector for collecting currents of the anode active material. Examples of the material for the cathode current collector may include SUS, aluminum, nickel, iron, titanium and carbon. Meanwhile, examples of the material for the anode current collector may include SUS, copper, nickel, and carbon. Also, as the battery case, a general battery case such as a battery case made of SUS may be used.

### 5. Solid State Battery

In some embodiments, the solid state battery is a lithium ion battery. In some embodiments, the solid state battery may be a primary battery and may be a secondary battery. The reason therefor is to be repeatedly charged and discharged and useful as a car-mounted battery for example. Incidentally, the secondary battery includes a secondary battery as a usage of a primary battery (usage for the purpose of just discharge once after charge). Also, examples of the shape of the solid state battery may include a coin shape, a laminate shape, a cylindrical shape and a square shape.

Incidentally, the present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### EXAMPLES

### Example 1

Li₂S (from Furuuchi Chemical Corporation, 0.8567 g), GeS₂ (from JAPAN PURE CHEMICAL CO., LTD., 0.4857 g), Sb₂S₃ (from JAPAN PURE CHEMICAL CO., LTD., 0.9048 g), S (from JAPAN PURE CHEMICAL CO., LTD., 0.1708 g), LiI (from JAPAN PURE CHEMICAL CO., LTD., 1.1883 g), and Li₂CO₃ (from JAPAN PURE CHEMICAL CO., LTD., 0.3936 g) were mixed by a mortar to obtain a raw material composition. The obtained raw material composition was put in a zirconium pot (500 ml) with zirconium balls, the pot was installed to a planetary ball milling device (Fritch P-5), and mechanical milling was conducted at the revolving speed of 300 rpm for 20 hours. Thereby, a precursor was obtained. The obtained precursor was fired under an Ar flow atmosphere at a temperature of crystallization temperature or more for 6 hours. Thereby, a sulfide solid electrolyte was obtained. The composition of the obtained sulfide solid electrolyte corresponded to “a”=1.0, “b”=0.6 in (2-a-b)Li₂S-aLiI-bLi₂CO₃—Li₄(Ge_{0.4}Sb_{0.6})S₄.

### Example 2

A sulfide solid electrolyte was obtained in the same manner as in Example 1, except that the composition of the raw material composition was changed to Li₂S (0.7201 g), GeS₂ (0.4512 g), Sb₂S₃ (0.8409 g), S (0.1587 g), LiI (1.1039 g), and Li₂CO₃ (0.4875 g). The composition of the obtained sulfide solid electrolyte corresponded to “a”=1.0, “b”=0.8 in (2-a-b)Li₂S-aLiI-bLi₂CO₃—Li₄(Ge_{0.4}Sb_{0.6})S₄.

### Example 3

A sulfide solid electrolyte was obtained in the same manner as in Example 1, except that the composition of the raw material composition was changed to Li₂S (0.7201 g), GeS₂ (0.4512 g), Sb₂S₃ (0.8406 g), S (0.1587 g), LiI (1.1039 g), and Li₂SO₄ (0.7255 g). The composition of the obtained sulfide solid electrolyte corresponded to “a”=1.0, “b”=0.8 in (2-a-b)Li₂S-aLiI-bLi₂SO₄—Li₄(Ge_{0.4}Sb_{0.6})S₄.

### Example 4

A sulfide solid electrolyte was obtained in the same manner as in Example 1, except that the composition of the raw material composition was changed to Li₂S (0.7846 g), GeS₂ (0.4961 g), Sb₂S₃ (0.8739 g), S (0.1650 g), LiI (1.1477 g), and LiBr (0.5957 g). The composition of the obtained sulfide solid electrolyte corresponded to “a”=1.0, “b”=0.8 in (2-a-b)Li₂S-aLiI-bLiBr—Li₄(Ge_{0.4}Sb_{0.6})S₄.

### Comparative Example 1

A sulfide solid electrolyte was obtained in the same manner as in Example 1, except that the composition of the raw material composition was changed to Li₂S (1.3083 g), GeS₂ (0.5769 g), P₂S₅ (0.7033 g), and LiI (1.4115 g). The composition of the obtained sulfide solid electrolyte corresponded to “a”=1.0 in (2-a)Li₂S-aLiI-Li₄(Ge_{0.4}P_{0.6})S₄.

### Comparative Example 2

A sulfide solid electrolyte was obtained in the same manner as in Example 1, except that the composition of the raw material composition was changed to Li₂S (1.144 g), GeS₂ (0.5045 g), Sb₂S₃ (0.9398 g), S (0.1774 g), and LiI (1.2342 g). The composition of the obtained sulfide solid electrolyte corresponded to “a”=1.0 in (2-a)Li₂S-aLiI-Li₄(Ge_{0.4}Sb_{0.6})S₄.

### Comparative Example 3

A sulfide solid electrolyte was obtained in the same manner as in Example 1, except that the composition of the raw material composition was changed to Li₂S (0.7934 g), GeS₂ (0.4498 g), Sb₂S₃ (0.8379 g), S (0.1582 g), and LiI (1.7607 g). The composition of the obtained sulfide solid electrolyte corresponded to “a”=1.6 in (2-a)Li₂S-aLiI-Li₄(Ge_{0.4}Sb_{0.6})S₄.

### Comparative Example 4

A sulfide solid electrolyte was obtained in the same manner as in Example 1, except that the composition of the raw material composition was changed to Li₂S (0.6928 g), GeS₂ (0.4341 g), Sb₂S₃ (0.8087 g), S (0.1527 g), and LiI (1.9117 g). The composition of the obtained sulfide solid electrolyte corresponded to “a”=1.8 in (2-a)Li₂S-aLiI-Li₄(Ge_{0.4}Sb_{0.6})S₄.

### Comparative Example 5

A sulfide solid electrolyte was obtained in the same manner as in Example 1, except that the composition of the raw material composition was changed to Li₂S (0.8104 g), GeS₂ (0.5078 g), Sb₂S₃ (0.946 g), S (0.1786 g), LiI (1.2424 g), and LiCl (0.3148 g). The composition of the obtained sulfide solid electrolyte corresponded to “a”=1.0, “b”=0.8 in (2-a-b)Li₂S-aLiI-bLiCl—Li₄(Ge_{0.4}Sb_{0.6})S₄. Incidentally, the ionic radius of a chloride ion (Cl⁻) is smaller than the ionic radius of a sulfide ion (S²⁻).

### Comparative Example 6

A sulfide solid electrolyte was obtained in the same manner as in Example 1, except that the composition of the raw material composition was changed to Li₂S (0.8815 g), GeS₂ (0.5524 g), Sb₂S₃ (1.0290 g), S (0.1943 g), and Li₂CO₃ (1.3429 g). The composition of the obtained sulfide solid electrolyte corresponded to “a”=0, “b”=1.8 in (2-a-b)Li₂S-aLiI-bLi₂CO₃—Li₄(Ge_{0.4}Sb_{0.6})S₄.

### Evaluation

### XRD Measurement

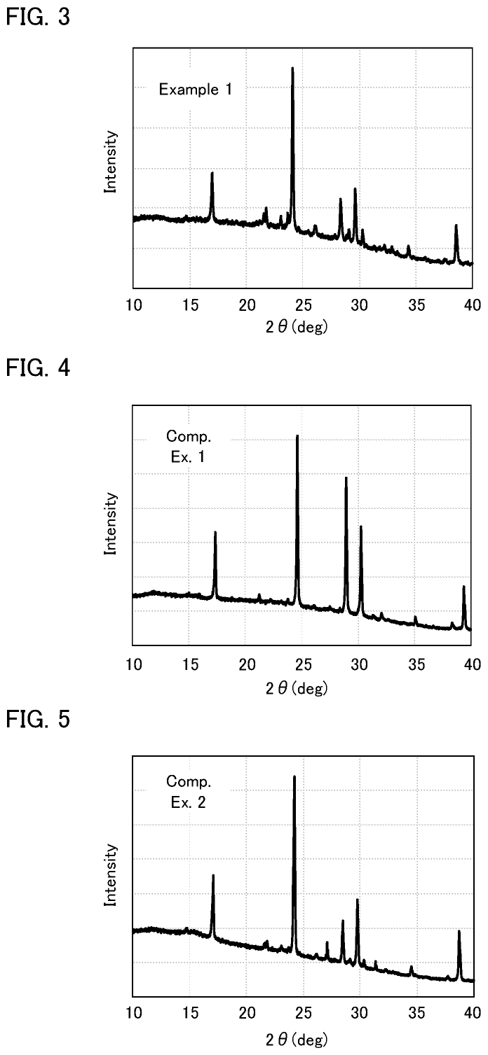

An X-ray diffraction (XRD) measurement using a CuKα ray was respectively conducted to the sulfide solid electrolytes obtained in Examples 1 to 4 and Comparative Examples 1 to 6. As representative results, results of Example 1, and Comparative Examples 1 to 2 are respectively shown in FIG. 3 to FIG. 5. As shown in FIG. 3 to FIG. 5, it was confirmed that all the sulfide solid electrolytes obtained in Example 1, and Comparative Examples 1 to 2 had the argyrodite type crystal phase. Also, although not illustrated in particular, it was also confirmed that the sulfide solid electrolytes obtained in Examples 2 to 4 had the argyrodite type crystal phase similarly to Example 1. Meanwhile, in the sulfide solid electrolyte obtained in Comparative Example 3, the peak of LiI was also confirmed in addition to the peak of the argyrodite type crystal phase. Also, in the sulfide solid electrolytes obtained in Comparative Examples 4 to 6, the argyrodite type crystal phase was not confirmed.

### Water Resistance Test

Water resistance tests were conducted to the sulfide solid electrolytes obtained in Examples 1 to 4 and Comparative Examples 1 to 6. In specific, a desiccator of 1.5 L was put in a dry air globe box with a dew point of −30° C., an Al container including 2 g of the sulfide solid electrolyte was placed in the desiccator, a cover of the desiccator was closed, and the container was placed still for 1 hour with a fan running. On that occasion, H₂S generated was measured by a sensor, and the generation amount per hour was calculated. The results are shown in Table 1.

### Ion Conductivity Measurement

Ion conductivity measurements (25° C.) were respectively conducted to the sulfide solid electrolytes obtained in Examples 1 to 4 and Comparative Examples 1 to 6. In specific, 100 mg powder of the obtained sulfide solid electrolyte was put in a ceramic cylinder with current collectors, and pressed at the pressure of 6 ton/cm² to produce a pressure powder cell. The produced pressure powder cell was subjected to an A.C. impedance method at a room temperature, and the ion conductivity was obtained from the resistance value and the thickness of the pellet. The results are shown in Table 1.

TABLE 1

| | | | | | | Amount | | | |
|---|---|---|---|---|---|---|---|---|---|
| | | | | | | of S | | H₂S | |
| | | First anion | | Second anion | | isolated | Precipitated | amount | Conductivity |
| | Cation | Kind | a | Kind | b | (2-a-b) | phase | (ppm/h) | (mS/cm) |
| Example 1 | Ge, Sb | I | 1.0 | CO₃ | 0.6 | 0.4 | ARG | 7 | 0.7 |
| Example 2 | Ge, Sb | I | 1.0 | CO₃ | 0.8 | 0.2 | ARG | 5 | 0.44 |
| Example 3 | Ge, Sb | I | 1.0 | SO₄ | 0.8 | 0.2 | ARG | 9 | 0.2 |
| Example 4 | Ge, Sb | I | 1.0 | Br | 0.8 | 0.2 | ARG | 18 | 0.12 |
| Comp. Ex. 1 | Ge, P | I | 1.0 | — | 0 | 1.0 | ARG | 166 | 5.4 |
| Comp. Ex. 2 | Ge, Sb | I | 1.0 | — | 0 | 1.0 | ARG | 60 | 3.5 |
| Comp. Ex. 3 | Ge, Sb | I | 1.6 | — | 0 | 0.4 | ARG, Lil | 36 | 0.45 |
| Comp. Ex. 4 | Ge, Sb | I | 1.8 | — | 0 | 0.2 | Heterogeneous | 28 | 0.079 |
| | | | | | | | phase | | |
| Comp. Ex. 5 | Ge, Sb | I | 1.0 | Cl | 0.8 | 0.2 | Heterogeneous | 37 | 0.016 |
| | | | | | | | phase | | |
| Comp. Ex. 6 | Ge, Sb | — | 0 | CO₃ | 1.8 | 0.2 | Heterogeneous | 32 | 0.011 |
| | | | | | | | phase | | |

As shown in Table 1, it was confirmed that the H2S amounts of Examples 1 to 4 were remarkably lower than those of Comparative Example 1, although the conductivity was low. This is presumably because the sulfide solid electrolytes obtained in Examples 1 to 4 did not contain a P element. Also, the H₂S amounts of Examples 1 to 4 were lower than those of Comparative Example 2. This is presumably because the sulfide solid electrolytes obtained in Examples 1 to 4 contained the A anion of which ionic radius is larger than that of the sulfide ion, and thus the amount S isolated was low.

Here, as shown in Comparative Examples 3 to 4, when the proportion of the first anion is increased, the sulfide solid electrolyte with the argyrodite type crystal phase is not easily obtained. Also, as shown in Comparative Example 5, as the second anion, also when a Cl ion (ion with smaller ionic radius than that of the sulfide ion) is used, the sulfide solid electrolyte with the argyrodite type crystal phase was not obtained. Also, as shown in Comparative Example 6, when the I ion, which is the first anion was not used, and the proportion of CO₃ ion which is the second anion was increased, the sulfide solid electrolyte with the argyrodite type crystal phase was not obtained. In contrast, in Examples 1 to 4, the I ion was used as the first anion, and further the A anion was used as the second anion, and thus the water resistance improved while maintaining the argyrodite type crystal phase.

### REFERENCE SIGNS LIST

1 cathode layer

2 anode layer

3 solid electrolyte layer

4 cathode current collector

5 anode current collector

6 battery case

10 solid state battery

What is claimed is:

1. A sulfide solid electrolyte comprising:
an argyrodite type crystal phase; and
containing Li, Ge, Sb, S, I, and A, the A is an anion with ionic radius larger than that of a sulfide ion.

2. The sulfide solid electrolyte according to claim 1, wherein the sulfide solid electrolyte does not contain P.

3. The sulfide solid electrolyte according to claim 1, wherein:
the sulfide solid electrolyte contains P; and
a proportion of P with respect to a total of Ge, Sb, and P is 50 mol % or less.

4. The sulfide solid electrolyte according to claim 1, wherein the A includes a polyatomic anion with a plurality of O.

5. The sulfide solid electrolyte according to claim 4, wherein the polyatomic anion includes C, S, or N as a cation.

6. The sulfide solid electrolyte according to claim 1, wherein the A includes at least one of a carbonate ion CO₃²⁻ and a sulfate ion SO₄²⁻.

7. The sulfide solid electrolyte according to claim 1, wherein the A includes a bromide ion Br⁻.

8. The sulfide solid electrolyte according to claim 1, wherein:
the sulfide solid electrolyte has a composition represented by (2-a-b)Li₂S-aLiI-bLi_{α}A-Li₄(Ge,Sb)S₄; and
the “a” satisfies 0<a<2, the “b” satisfies 0<b<2, the “a” and the “b” satisfy 0<a+b<2, and the “α” is a value corresponding to a valence of the A.

9. The sulfide solid electrolyte according to claim 8, wherein the “a” and the “b” satisfy 1.5≤a+b≤1.9.

10. The sulfide solid electrolyte according to claim 8, wherein the “a” satisfies 0.8≤a≤1.2.

11. The sulfide solid electrolyte according to claim 8, wherein the “b” satisfies 0.4 b 1.0.

12. A solid battery comprising a cathode layer, an anode layer, and a solid electrolyte layer formed between the cathode layer and the anode layer, wherein
at least one of the cathode layer, the anode layer, and the solid electrolyte layer contains the sulfide solid electrolyte according to claim 1.
